(19) United States
(12) Patent Application Publication
(10) Pub. No.: US 2006/0083258 A1
(43) Pub. Date: Apr. 20, 2006

(54) Time allocation method for synchronous ethernet network

(75) Inventors: Seo-Won Kwon, Seoul (KR); Jae-Yeon Song, Seoul (KR); Se-Youn Lim, Seoul (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/179,754

(22) Filed: Jul. 12, 2005

(30) Foreign Application Priority Data
Oct. 15, 2004 (KR) 2004-82623

(51) Int. Cl. H04L 12/43

(52) U.S. Cl. 370/458

(57) ABSTRACT

Disclosed is a time allocation method for a synchronous Ethernet network. The time allocation method for a synchronous Ethernet network including a gateway allocating time based on a cycle including an asynchronous part and a synchronous part and a plurality of network end points connected to the gateway, includes the steps of (a) preparing a plurality of time slots by multi-dividing the synchronous part in one cycle, and (b) allocating each time slot to a plurality of network end points participating in communication in a corresponding cycle in common.

### CLAIM OF PRIORITY

This application claims priority to an application entitled “Time Allocation Method For Synchronous Ethernet Network,” filed in the Korean Intellectual Property Office on Oct. 15, 2004 and assigned Serial No. 2004-82623, the contents of which are incorporated herein by reference.

### BACKGROUND OF THE INVENTION

1. Field of the Invention

The present invention relates to synchronous Ethernet, and more particularly to a synchronous Ethernet network and a time allocation method that may be utilized in the synchronous Ethernet network.

2. Description of the Related Art

Synchronous Ethernet is one of many techniques used to transmit real time data such as voice/video data. The synchronous Ethernet is connected to an external network so as to cover a certain residential area, and includes a gateway and stations (network end points connected to the gateway). Currently, the synchronous Ethernet network assigns time for transmission based on a cycle including an asynchronous part and a synchronous part. The only standard which provides that each cycle corresponds to 125 μs and the synchronization between the stations is achieved according to the sync bit specified in a medium access control (MAC) layer for the synchronous Ethernet network.

FIG. 1 is a view showing a time allocation table 100 of a typical synchronous Ethernet network. As shown in FIG. 1, one cycle 110 in the time allocation table 100 includes an asynchronous (ASYNC) part 120 and a synchronous (SYNC) part 130 and has a bandwidth of 125 μs. Herein, asynchronous data are transmitted in the asynchronous part 120, and synchronous data such as real time data are transmitted in the synchronous part 130.

However, in the above-described typical synchronous Ethernet network, data are processed according to cycles and synchronous data transmitted by a certain station in a given cycle are stored in a buffer register of a gateway before being transmitted to a destination station in a next cycle. As a result, at least one cycle transmission delay during the real time data transmission occurs.

### SUMMARY OF THE INVENTION

Accordingly, the present invention has been made to solve the above-mentioned problems occurring in the prior art and provides additional advantages by providing a time allocation method for a synchronous Ethernet network capable of minimizing a transmission delay of synchronous data and also efficiently use a limited bandwidth.

In one embodiment, there is provided a time allocation method for a synchronous Ethernet network including a gateway and a plurality of network end points, the gateway allocating time based on a cycle including an asynchronous part and a synchronous part, the network end points connected to the gateway. The time allocation method including the steps of (a) preparing a plurality of time slots by multi-dividing the synchronous part in one cycle, and (b) allocating each time slot commonly to a plurality of network end-points participating in communication in a corresponding cycle.

### BRIEF DESCRIPTION OF THE DRAWINGS

The above features and advantages of the present invention will be more apparent from the following detailed description taken in conjunction with the accompanying drawings, in which:

FIG. 1 is a view showing a time allocation table of a typical synchronous Ethernet network;

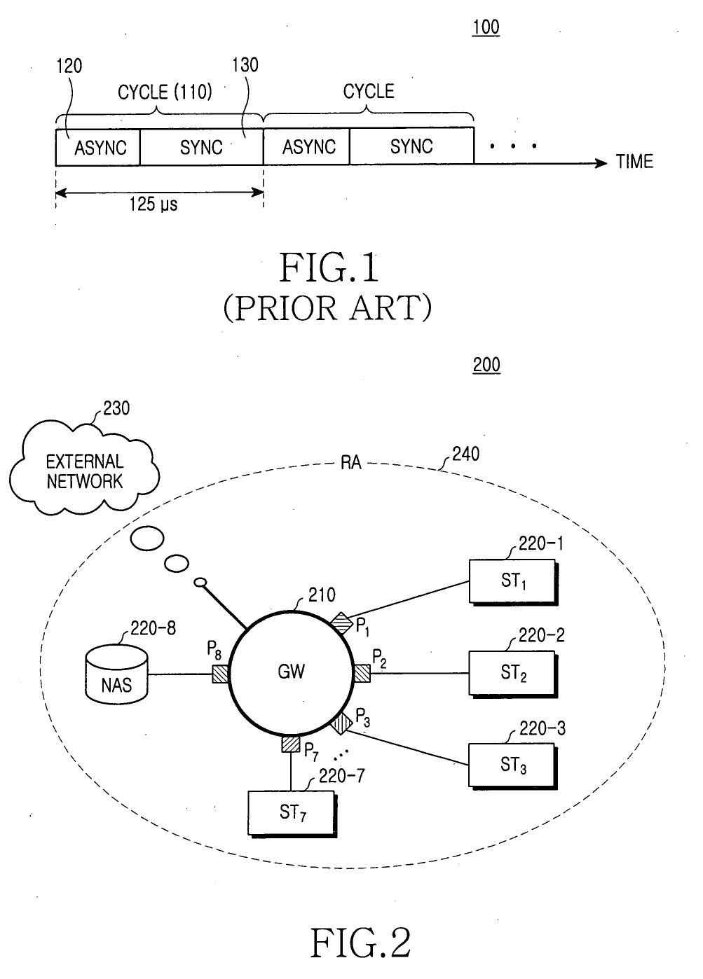

FIG. 2 is a view showing a structure of a synchronous Ethernet network according to a preferred embodiment of the present invention; and

FIGS. 3 and 4 are views for explaining a method for allocating time in a synchronous Ethernet network according to a preferred embodiment of the present invention.

### DETAILED DESCRIPTION

Hereinafter, an embodiment of the present invention will be described in detail with reference to the accompanying drawings. Note that the same or similar components in drawings are designated by the same reference numerals as far as possible although they are shown in different drawings. For the purposes of clarity and simplicity, a detailed description of known functions and configurations incorporated herein will be omitted as it may make the subject matter of the present invention unclear.

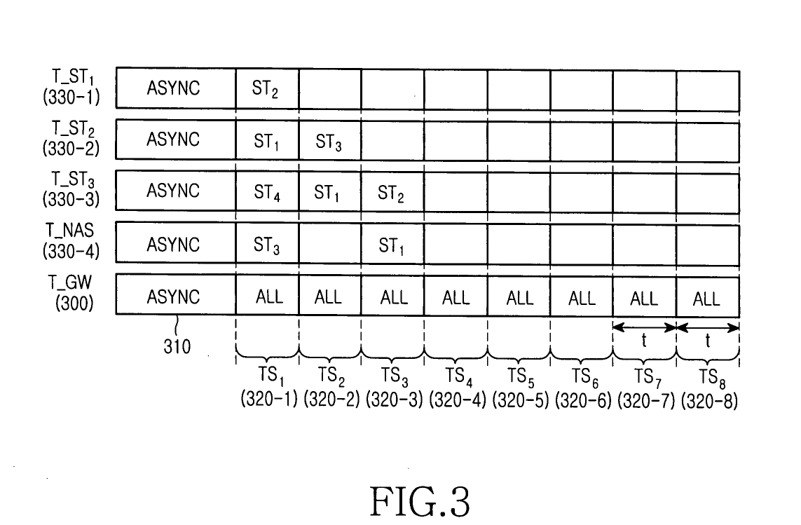

FIG. 2 is a view showing a structure of a synchronous Ethernet network 200 according to an embodiment of the present invention. The synchronous Ethernet network 200 is connected to an external network 230 such as Internet and includes a gateway (GW) 210, a first station (ST) to a seventh station (ST) 220-1 to 220-7, and a network attached-storage 220-8. Herein, the synchronous Ethernet network 200 covers one residential area (RA) such as an office or a home. Herein, each station refers to an apparatus (personal computer, etc.) in a client side.

The gateway 210 includes a first port (P) to an eighth port (P) and is connected to the external network 230. The gateway 210 may include a plurality of buffer registers for storing synchronous data received by each port and an Ethernet switch for switching and for transmitting the synchronous data stored in each buffer register into and to a destination station. In other words, an independent buffer register is provided to each port of the gateway, and the synchronous data stored in the buffer registers are simultaneously switched and transmitted into and to different destinations.

The first station to the seventh station 220-1 to 220-7 represent network end-points, and each station communicates with another station as well as with the external network 230 through the gateway 210 or the network attached-storage 220-8.

The network attached-storage 220-8 is a network end-point and connected to the eighth port of the gateway 210, stores real time data such as voice/video data, and provides a corresponding station with the stored real time data as synchronization data. The first station to the seventh station 220-1 to 220-7 and the network attached storage 220-8 have one-to-one connection with the first port to the eighth port of the gateway 210 in a star topology.

Now, a method for allocating time in the synchronous Ethernet network 200 will be described.

In operation, the gateway 210 is temporally synchronized with the network end points 220-1 to 220-8. The gateway 210 operates as a time master for the entire network 200. The gateway 210 allocates time to the network attached-storage 220-8 and the first station to the seventh station 220-1 to 220-7 based on a cycle including an asynchronous part and a synchronous part. One cycle has a bandwidth of 125 μs. Asynchronous data are transmitted in the asynchronous part, and synchronous data are transmitted in the synchronous part.

In following table 1, synchronization data transmitted from the synchronous Ethernet network 200 are shown by way of example. As shown, in transmission of first synchronization data (D1), the first station 220-1 corresponds to a source, and the second station 220-2 corresponds to a destination. Using this table, a method of allocating time in the synchronous Ethernet network 200 according to an embodiment of the present invention will be described.

TABLE 1

| Data | Source | Destination |
|---|---|---|
| D₁ | ST₁ | ST₂ |
| D₂; D₃ | ST₂ | ST₁; ST₃ |
| D₄; D₅; D₆ | ST₃ | ST₁; ST₂; ST₄ |
| D₇; D₈ | NAS | ST₁; ST₃ |

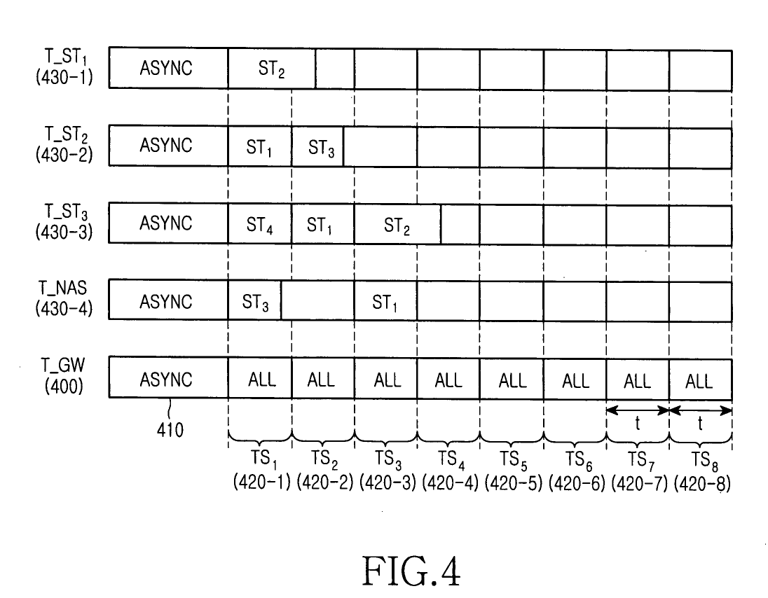

FIG. 3 shows the process of allocating time in the synchronous Ethernet network 200 according to the embodiment of the present invention. In FIG. 3, a time allocation table (T_GW) 300 of the synchronous Ethernet network 200, a transmission table (T_NAS) 330-4 of the network attached-storage 220-8, and transmission tables (T_STs) 330-1 to 330-3 of the first station to the third station 220-1 to 220-3 are shown. In other words, only network terminals of table 1 participating in data transmission are shown in FIG. 3. Herein, each transmission table shows a destination of synchronous data transmitted by a corresponding station.

More specifically, the method for allocating time in the synchronous Ethernet network 200 according to the present invention includes the two following steps:

(a) The synchronous part is divided into eight slots corresponding to the number of ports in one cycle having the synchronous part and the asynchronous part 310, thereby preparing a first time slot (TS) to an eighth time slot (TS) 320-1 to 320-8 in the synchronous part. Herein, each time slot (a bandwidth of the synchronous part/the number of ports) has a bandwidth of t; and

(b) Each divided time slot is commonly allocated to all the network attached storage 220-8 and the first station to the seventh station 220-1 to 220-7. In other words, each of the first time slot to the eighth time slot is allocated to any one of the network attached-storage 220-8 and the first station to the seventh station 220-1 to 220-7.

Accordingly, the gateway 210 processes synchronous data received with an interval of ‘t’ in the synchronous part. That is, the gateway 210 stores synchronous data transmitted from a given network end-point at a certain time slot in a buffer register, then transmits the synchronous data to a destination station in a next time slot, so that transmission delay of real time data is minimized. Under the condition that the same destinations are not repeatedly targeted at each time slot, the gateway simultaneously transmits synchronous data, which are received from a plurality of network end-points at the same time, to destination stations.

In operation, the first station 220-1 transmits first synchronous data at the first time slot 320-1. The second station 220-2 transmits second synchronous data at the first time slot 320-1 and third synchronous data at the second time slot 320-2. The third station 220-3 transmits sixth synchronous data at the first time slot 320-1, fourth synchronous data at the second time slot 320-2, and fifth synchronous data at the third time slot 320-3. The network attached storage 220-8 transmits eighth synchronous data at the first time slot 320-1 and seventh synchronous data at the third time slot 320-3.

FIG. 4 is a view for explaining the method for allocating time in the synchronous Ethernet network 200 according to another embodiment of the present invention with FIG. 3. FIG. 3 shows a case in which a bandwidth of synchronous data is identical to a bandwidth of a time slot, and FIG. 4 shows a case in which the bandwidth of the synchronous data is not identical to the bandwidth of the time slot. Hereinafter, description overlapping with that of FIG. 3 will be omitted to avoid redundancy.

In FIG. 4, a time allocation table (T_GW) 400 of the synchronous Ethernet network 200, a transmission table (T_NAS) 430-4 of the network attached storage 220-8, and transmission tables (T_STs) 430-1 to 430-3 of the first station to the third station 220-1 to 220-3 are shown. The time allocation table 400 including a synchronous part and an asynchronous part has a first time slot (TS) to an eighth time slot (TS) 420-1 to 420-8 in the synchronous part, and each time slot (a bandwidth of the synchronous part/the number or ports) has a bandwidth of t. Each of the first time slot to the eighth time slot 420-1 to 420-8 are commonly allocated to the network attached storage 220-8 and the first station to the seventh station 220-1 to 220-7.

In operation, the first station 220-1 transmits first synchronous data at both a first time slot and a second time slot 420-1 and 420-2. The second station 220-2 transmits second synchronous data at the first time slot 420-1 and third synchronous data at the second time slot 420-2. The third station 220-3 transmits sixth synchronous data at the first time slot 420-1, fourth synchronous data at the second time slot 420-2, and fifth synchronous data at the third time slot and the fourth time slot 420-3 and 420-4. The network attached storage 220-8 transmits eighth synchronous data at the first time slot 420-1 and seventh synchronous data at the third time slot 420-3.

As described above, a time allocation method for a synchronous Ethernet network according to the present invention divides a synchronous part in one cycle by the number of gateway ports and commonly allocates each divided time slot to a plurality of network end-points participating in communication in a cycle corresponding to the divided time slot, so that transmission delay of real time data may be minimized and a limited bandwidth may be efficiently used.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A time allocation method for a synchronous Ethernet network including a gateway and a plurality of network end points, the gateway allocating time based on a cycle including an asynchronous part and a synchronous part, the network end points connected to the gateway, the time allocation method comprising the steps of:
(a) preparing a plurality of time slots by multi-dividing the synchronous part in one cycle; and
(b) commonly allocating each time slot to a plurality of network end-points participating in communication in a corresponding cycle.

2. The time allocation method as claimed in claim 1, wherein, in step (b), each time slot is allocated to all network end points participating in communication in a corresponding cycle.

3. The time allocation method as claimed in claim 1, wherein, in step (b), identical destinations are not repeatedly targeted in a given time slot.
